(19) United States
(12) Patent Application Publication
(10) Pub. No.: US 2026/0067797 A1
(43) Pub. Date: Mar. 5, 2026

(54) INFORMATION PROCESSING APPARATUS, METHOD, AND STORAGE MEDIUM STORING PROGRAM

(71) Applicant: CANON KABUSHIKI KAISHA, Tokyo (JP)

(72) Inventor: TAIKI TOMIZAWA, Kanagawa (JP)

(21) Appl. No.: 19/303,621

(22) Filed: Aug. 19, 2025

(30) Foreign Application Priority Data
Aug. 27, 2024 (JP) 2024-145867

(51) Int. Cl. H04W 48/20; H04M 1/72403; H04M 1/72457; H04M 1/72469; H04W 76/10

(52) U.S. Cl. CPC H04W 48/20; H04M 1/72403; H04M 1/72457; H04M 1/72469; H04W 76/10

(57) ABSTRACT

An information processing apparatus executes processing for obtaining information of a predetermined access point from an operating system (OS) based on a state where the predetermined application program is in a first state; executes processing for displaying a first dialog screen which is a dialog screen for placing the predetermined application program in the first state, and which is a dialog screen displayed by the OS, based on a state where the predetermined application program is in a second state; executes processing for displaying a second dialog screen which is a dialog screen for placing the predetermined application program in the first state, which is a dialog screen displayed by the OS, and which is different from the first dialog screen, based on a state where the predetermined application program is a third state.

### BACKGROUND

### Field of the Technology

The present disclosure relates to an information processing apparatus, a method, and a storage medium storing a program.

### Description of the Related Art

There is a known technique in which an information processing apparatus, such as a smartphone, temporarily connects to a communication apparatus, such as a printer, and transmits information related to access points; this enables the information processing apparatus and the communication apparatus to connect to access points with the same SSID. Also, Japanese Patent Laid-Open No. 2016-127545 indicates a method in which an SSID selected by a user from an SSID list of connectable access points around a communication apparatus is used as an access point for connecting an information processing apparatus and the communication apparatus, and a method in which an SSID to which the information processing apparatus was connected immediately before temporary connection to the communication apparatus is used as the access point.

### SUMMARY

The present disclosure provides an information processing apparatus, a method, and a storage medium storing a program that improve convenience in causing a communication apparatus to connect to an access point to which the information processing apparatus was connected immediately before connecting to the communication apparatus.

The present disclosure in one aspect provides a method of controlling an information processing apparatus capable of accepting a first operation for permitting a predetermined application program to use position information, and a second operation for not permitting the predetermined application program to use the position information, the method comprising: executing processing for obtaining information of a predetermined access point to which the information processing apparatus is connected from an operating system (OS) of the information processing apparatus based on a state where the predetermined application program is in a first state which is a state where the predetermined application program is permitted to use the position information, and which is a state based on a state where the first operation has been executed; transmitting the information of the predetermined access point obtained from the OS of the information processing apparatus to a communication apparatus; executing processing for displaying a first dialog screen which is a dialog screen for placing the predetermined application program in the first state, and which is a dialog screen displayed by the OS of the information processing apparatus, based on a state where the predetermined application program is in a second state which is a state based on a state where neither the first operation nor the second operation has been executed; and executing processing for displaying a second dialog screen which is a dialog screen for placing the predetermined application program in the first state, which is a dialog screen displayed by the OS of the information processing apparatus, and which is different from the first dialog screen, based on a state where the predetermined application program is a third state which is a state where the predetermined application program is not permitted to use the position information, and which is a state based on a state where the second operation has been executed.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram showing a configuration of a communication system.

FIG. 2 is a diagram showing configurations of an information processing apparatus and a communication apparatus.

FIGS. 3A and 3B are flowcharts showing processing executed by the information processing apparatus.

FIG. 4 is a diagram showing a user interface screen.

FIG. 5 is a diagram showing a user interface screen.

FIG. 6 is a diagram showing a user interface screen.

FIG. 7 is a diagram showing a user interface screen.

FIG. 8 is a diagram showing a user interface screen.

FIG. 9 is a diagram showing a user interface screen.

FIG. 10 is a flowchart showing processing executed by the information processing apparatus.

FIG. 11 is a diagram showing a user interface screen.

### DESCRIPTION OF THE EMBODIMENTS

Hereinafter, embodiments will be described in detail with reference to the attached drawings. Note, the following embodiments are not intended to limit the scope of the disclosure. Multiple features are described in the embodiments, but limitation is not made the disclosure that requires all such features, and multiple such features may be combined as appropriate. Furthermore, in the attached drawings, the same reference numerals are given to the same or similar configurations, and redundant description thereof is omitted.

There is desire for improvements in convenience in using an access point to which an information processing apparatus was connected immediately before connecting to a communication apparatus as an access point to which the communication apparatus is to connect.

The present disclosure can improve convenience in causing a communication apparatus to connect to an access point to which an information processing apparatus was connected immediately before connecting to the communication apparatus.

An information processing apparatus and a communication apparatus included in a communication system of the present embodiment will be described. The information processing apparatus is also called a terminal apparatus. Although a smartphone is exemplarily presented as the information processing apparatus in the present embodiment, no limitation is intended by this. For example, various types of apparatuses, such as a personal computer (PC), a tablet terminal, a personal digital assistant (PDA), and a digital camera, are applicable as the information processing apparatus. Also, in the present embodiment, a printer is exemplarily presented as the communication apparatus. The printer may be an inkjet printer that performs printing using ink, or may be a laser beam printer than performs printing using toner. Furthermore, the printer may be a full-color printer that can perform color printing, or may be a monochrome printer that cannot perform color printing but can perform monochrome printing. Note that in the present embodiment, the communication apparatus is not limited to the printer, and an apparatus that can perform wireless communication with the information processing apparatus is applicable as the communication apparatus. The communication apparatus is also applicable to, for example, a copier, a facsimile apparatus, a scanner, a smartphone, a PC, a tablet terminal, a PDA, a digital camera, a music reproduction device, a television, a smart speaker, a robot cleaner, an automatic cooker, a refrigerator, and the like. In addition, the communication apparatus is also applicable to, for example, a multi-functional peripheral that has a plurality of functions, such as a copy function, a FAX function, and a print function.

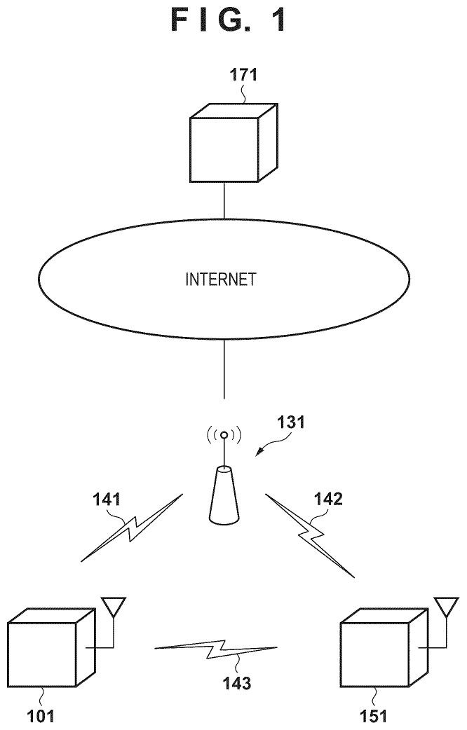

First, a system configuration for realizing the present embodiment will be described. FIG. 1 is a diagram showing an example of a configuration of a communication system of the present embodiment. It is assumed that this system includes a communication apparatus 151, an information processing apparatus 101, an access point (AP) 131, and an external server 171.

The information processing apparatus 101 is an information processing apparatus of the present embodiment. The communication apparatus 151 is a communication apparatus of the present embodiment. The AP 131 is an access point that is activated by an external apparatus that exists outside the information processing apparatus 101 and outside the communication apparatus 151. The external apparatus is, for example, a wireless local area network (LAN) router. The external server 171 is a server capable of providing services to apparatuses connected to the AP 131 via the Internet.

In a status where the communication apparatus 151 and the information processing apparatus 101 are connected to the AP 131, a LAN formed by the AP 131 includes the AP 131, the communication apparatus 151, and the information processing apparatus 101. On the other hand, a wide area network (WAN) includes the AP 131 and the external server 171.

In the present embodiment, in a case where later-described infrastructure connection has been established, the information processing apparatus 101 can communicate with the communication apparatus 151 via the AP 131. Furthermore, in a case where later-described direct connection has been established, the information processing apparatus 101 can communicate directly with the communication apparatus 151 without intervention of the AP 131. Note that, hereinafter, connection with an AP corresponds to connection with a network formed by the AP. Note that one external apparatus may activate a plurality of APs, and one external apparatus may be capable of forming a plurality of networks simultaneously.

In the present embodiment, it is assumed that connection 141 between the information processing apparatus 101 and the AP 131, as well as connection 142 between the communication apparatus 151 and the AP 131, is connection pursuant to a communication method based on the standards of the IEEE 802.11 series. A communication method based on the standards of the IEEE 802.11 series is specifically Wireless Fidelity (Wi-Fi)®. Furthermore, it is assumed that connection 143 between the information processing apparatus 101 and the communication apparatus 151 is also connection pursuant to a communication method based on the standards of the IEEE 802.11 series. However, a communication method used for connection 143 is not limited to this style, and may be, for example, Bluetooth® Low Energy (BLE), Bluetooth Classic, Wi-Fi Aware, Near Field Communication (NFC), and the like. The AP 131 and the external server 171 can communicate via the Internet; in a state where the AP 131 is connected to the Internet, the apparatuses (the information processing apparatus 101 and the communication apparatus 151) connected to the AP 131 can also use the Internet. Note that connection 141 between the information processing apparatus 101 and the AP 131, as well as connection 142 between the communication apparatus 151 and the AP 131, may be connection pursuant to a wired LAN.

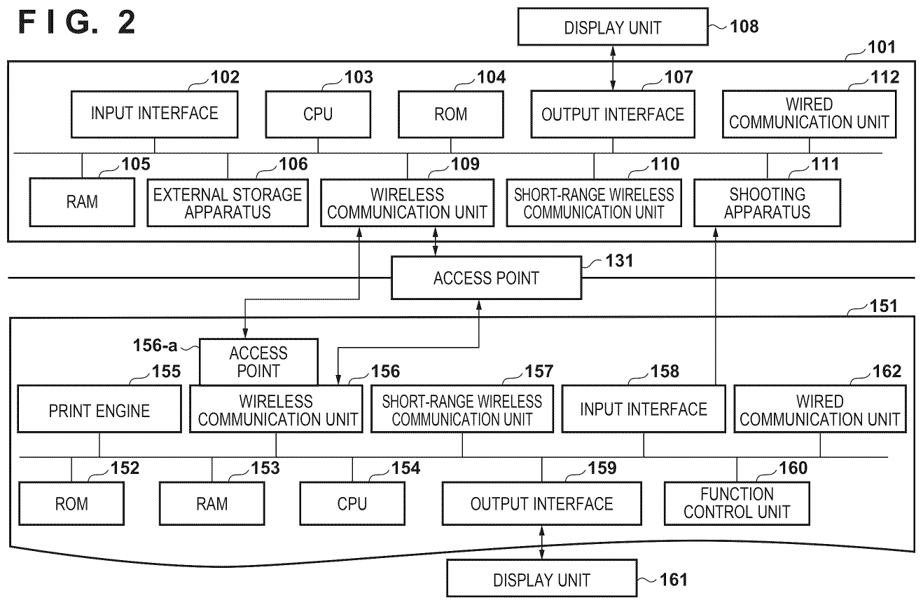

Next, configurations of the information processing apparatus of the present embodiment and the communication apparatus that can communicate with the information processing apparatus of the present embodiment will be described with reference to a block diagram of FIG. 2. Also, although the present embodiment will be described using the following configurations as an example, the present embodiment is applicable in relation to an apparatus capable of communicating with the communication apparatus, and the functions are not particularly limited to this diagram.

The information processing apparatus 101 includes an input interface 102, a CPU 103, a ROM 104, a RAM 105, an external storage apparatus 106, an output interface 107, a display unit 108, a wireless communication unit 109, a short-range wireless communication unit 110, a shooting apparatus 111, a wired communication unit 112, and the like. The CPU 103, the ROM 104, the RAM 105, and the like form a computer of the information processing apparatus 101.

The input interface 102 is an interface capable of accepting a data input and an operational instruction from a user, and is composed of a physical keyboard, buttons, a touch panel, and the like. Note that it is possible to adopt a style in which the later-described output interface 107 and the input interface 102 are the same constituent, and outputting of a screen and acceptance of a user operation are performed on the same constituent.

The CPU 103 is a system control unit, and controls an entirety of the information processing apparatus 101. In the present embodiment, the CPU 103 executes, for example, control on the contents displayed on the display unit 108 (display control).

The ROM 104 stores fixed data, such as control programs executed by the CPU 103, data tables, and an operating system (hereinafter referred to as an OS) program. Note that in the present embodiment, iOS or iPadOS® is assumed as an example of the OS. In the present embodiment, under management of a built-in OS stored in the ROM 104, each control program stored in the ROM 104 performs software execution control, such as scheduling, task switching, and interrupt processing. In the present embodiment, the ROM 104 stores a predetermined application program (app) for controlling the communication apparatus 151. An application program is, in other words, application software. The predetermined app is installed on the information processing apparatus 101 from outside by, for example, a store app for installing various types of apps. Also, the predetermined app is an app provided by a vendor of the communication apparatus 151, and is an app for communicating with the communication apparatus 151 and performing connection settings of the communication apparatus 151. Note that the predetermined app may have other functions different from the function of performing connection settings of the communication apparatus 151. Specifically, the other functions are, for example, a function of transmitting a print job for causing the communication apparatus 151 to execute printing (a print job transmission function), and a function of transmitting a scan job for causing the communication apparatus 151 to execute a scan (a scan job transmission function). Note that processing that is described as processing executed by the OS in the present embodiment is, to be exact, processing executed by the CPU 103 in accordance with a program inside the OS. Similarly, processing that is described as processing executed by an app is, to be exact, processing executed by the CPU 103 in accordance with a program inside the app.

The RAM 105 is composed of, for example, a static random-access memory (SRAM) that requires a backup power source. Note that as the RAM 105 holds data with use of a non-illustrated primary battery for data backup, it can store such important data as variables for program control without rendering the data volatile. Also, a memory area that stores setting information of the information processing apparatus 101, management data of the information processing apparatus 101, and the like is also provided in the RAM 105. Furthermore, the RAM 105 is also used as a main memory and a working memory for the CPU 103.

The external storage apparatus 106 includes various types of programs, such as a print information generation program that generates print information that can be interpreted by the communication apparatus 151, and an information transmission/reception control program that performs transmission/reception with the communication apparatus 151 connected via the wireless communication unit 109. In addition, various types of information used by these programs, and image data obtained from other information processing apparatuses and the Internet, are also saved in the external storage apparatus 106.

The output interface 107 is an interface that performs control for the display unit 108 to display data and provide a notification of a state of the information processing apparatus 101.

The display unit 108 is composed of a light-emitting diode (LED), a liquid crystal display (LCD), and the like, and displays data and provides a notification of a state of the information processing apparatus 101. Note that an input from the user may be accepted via the display unit 108 by mounting a software keyboard including such keys as numeric value input keys, mode setting keys, a decision key, a cancel key, and a power source key, on the display unit 108. In the present embodiment, it is assumed that the display unit 108 is a touch panel and is capable of accepting an operation from the user via a finger, a stylus, and the like.

The wireless communication unit 109 is configured to wirelessly connect to such apparatuses as the communication apparatus 151 and the AP 131 and execute data communication. For example, the wireless communication unit 109 may communicate with the communication apparatus 151 directly via wireless communication, or may communicate therewith via the AP 131 that exits outside the information processing apparatus 101 and the communication apparatus 151. Although it is assumed in the present embodiment that Wi-Fi, which is a communication method based on the IEEE 802.11 standards, is used as a wireless communication method of the wireless communication unit 109, Bluetooth Classic and the like may be used. Also, it is assumed in the present embodiment that a wireless LAN is a Wi-Fi network. Note that in the present embodiment, connection pursuant to a method whereby the information processing apparatus 101 and the communication apparatus 151 directly connect to each other without intervention of an external AP is referred to as direct connection. Also, connection pursuant to a method whereby the information processing apparatus 101 and the communication apparatus 151 connect to each other via an external AP is referred to as infrastructure connection (infra connection).

The short-range wireless communication unit 110 is configured to execute data communication with an apparatus, such as the communication apparatus 151, using a short-range wireless communication method, and performs communication using a communication method different from that of the wireless communication unit 109. The short-range wireless communication unit 110 can connect to a short-range wireless communication unit 157 inside the communication apparatus 151. Note that examples of the communication method of the short-range wireless communication unit 110 include BLE, Bluetooth Classic, Wi-Fi Aware, NFC, and the like.

The shooting apparatus 111 is an apparatus that converts an image shot by an image sensor into digital data. The digital data is stored into the RAM 105. Thereafter, the digital data is converted into a predetermined image format by a program executed by the CPU 103, and saved as image data into the external storage apparatus 106.

The wired communication unit 112 is configured to connect to such apparatuses as the communication apparatus 151 and the AP 131 by wire and execute data communication. For example, the wired communication unit 112 performs communication via a wired LAN. In the present embodiment, it is assumed that communication is performed in accordance with the Ethernet standard in the wired LAN. Note that no limitation is intended by this style, and the wired communication unit 112 may perform communication via, for example, a Universal Serial Bus (USB) cable. Also, for example, in a case where the information processing apparatus 101 is a smartphone, the information processing apparatus 101 may not include the wired communication unit 112.

The communication apparatus 151 includes a ROM 152, a RAM 153, a CPU 154, a print engine 155, a wireless communication unit 156, a short-range wireless communication unit 157, an input interface 158, an output interface 159, a function control unit 160, a display unit 161, a wired communication unit 162, and the like. The ROM 152, the RAM 153, the CPU 154, and the like form a computer of the communication apparatus 151.

The wireless communication unit 156 is configured to wirelessly connect to such apparatuses as the information processing apparatus 101 and the AP 131 and execute data communication. Although it is assumed in the present embodiment that Wi-Fi, which is a communication method based on the IEEE 802.11 standards, is used as a wireless communication method of the wireless communication unit 156, Bluetooth Classic and the like may be used. Note that the wireless communication unit 156 includes an AP 156-a for connecting to an apparatus, such as the information processing apparatus 101, as an internal AP of the communication apparatus 151. Note that this AP is connectable to the wireless communication unit 109 of the information processing apparatus 101. Note that the wireless communication unit 156 may communicate directly with the information processing apparatus 101 via the AP 156-a, or may communicate with the information processing apparatus 101 via the AP 131. Also, the AP 156-a may be hardware that functions as an AP, or the wireless communication unit 156 may operate as the AP 156-a by using software that is intended to function as an AP. Furthermore, the communication apparatus 151 may be capable of activating, thereinside, a plurality of APs that have different service set identifiers (SSIDs) and passwords.

The RAM 153 is composed of, for example, a DRAM that requires a backup power source. Note that as the RAM 153 holds data due to a supply of a non-illustrated power source for data backup, it can store such important data as variables for program control without rendering the data volatile. Furthermore, the RAM 153 is also used as a main memory and a working memory for the CPU 154, and saves various types of information as a reception buffer for temporarily saving print information received from the information processing apparatus 101 and the like.

The ROM 152 stores fixed data, such as control programs executed by the CPU 154, data tables, and an OS program. In the present embodiment, under management of a built-in OS stored in the ROM 152, each control program stored in the ROM 152 performs software execution control, such as scheduling, task switching, and interrupt processing. Furthermore, a memory area that stores data that needs to be held also in a case where a power source is not supplied, such as setting information of the communication apparatus 151 and management data of the communication apparatus 151, is also provided in the ROM 152.

The CPU 154 is a system control unit, and controls an entirety of the communication apparatus 151.

The print engine 155 forms an image on a printing medium, such as a sheet, using a printing agent like ink based on information saved in the RAM 153 or a print job received from the information processing apparatus 101 and the like, and outputs a print result. It is assumed that the print job transmitted from the information processing apparatus 101 and the like at this time is received via the wireless communication unit 156, which can perform communication at a higher speed than the short-range wireless communication unit 157, because the print job has a large amount of transmitted data and requires high-speed communication.

The short-range wireless communication unit 157 is configured to communicate with an apparatus, such as the information processing apparatus 101, using a short-range wireless communication method. Note that examples of the communication method of the short-range wireless communication unit 157 include BLE, Bluetooth Classic, Wi-Fi Aware, and the like.

The input interface 158 is an interface capable of accepting a data input and an operational instruction from the user, and is composed of a physical keyboard, buttons, a touch panel, and the like. Note that it is possible to adopt a style in which the later-described output interface 159 and the input interface 158 are the same constituent, and outputting of a screen and acceptance of a user operation are performed on the same constituent. The output interface 159 is an interface that performs control for the display unit 161 to display data and provide a notification of a state of the communication apparatus 151.

The function control unit 160 manages a functional operation regarding whether to cause the functions included in the communication apparatus 151 to operate simultaneously.

The display unit 161 is composed of a light-emitting diode (LED), a liquid crystal display (LCD), and the like, and displays data and provides a notification of a state of the communication apparatus 151. Note that an input from the user may be accepted via the display unit 161 by mounting a software keyboard including such keys as numeric value input keys, mode setting keys, a decision key, a cancel key, and a power source key, on the display unit 161.

The wired communication unit 162 is configured to connect to such apparatuses as the information processing apparatus 101 and the AP 131 by wire and execute data communication. For example, the wired communication unit 162 performs communication via a wired LAN. Note that no limitation is intended by this style, and communication may be performed via, for example, a USB cable.

### <Regarding Direct Connection Method>

Direct connection refers to a style in which apparatuses wirelessly connect to each other directly (i.e., by way of peer-to-peer) without intervention of an external apparatus, such as the AP 131. Direct connection is also referred to as peer-to-peer connection (P2P connection). The communication apparatus 151 can operate in a mode for performing communication via direct connection (a direct connection mode) as one of connection modes. In Wi-Fi communication, a plurality of modes exist as modes for performing communication via direct connection, such as a software AP mode and a Wi-Fi Direct (WFD) mode.

A mode that executes direct connection via WFD is referred to as a WFD mode. WFD is a standard formulated by the Wi-Fi Alliance, and is a standard included in the communication standards of the IEEE 802.11 series. In the WFD mode, after searching for a device to become a communication partner by using a device search command, the roles of a group owner (GO) of P2P and a client of P2P are decided, and then processing of the remaining wireless connection is executed. The group owner corresponds to a parent station (parent device) of Wi-Fi, and the client corresponds to a child station (child device) of Wi-Fi. This role decision corresponds to, for example, GO Negotiation in P2P. Note that in the WFD mode in a state before the role decision is made, the communication apparatus 151 is in a state where it is neither a parent station nor a child station. Specifically, first, one of devices that are to perform communication issues a device search command, and searches for a device to connect to in the WFD mode. Once another device to become a communication partner has been searched for, both devices confirm, with each other, information related to services and functions that can be supplied between each other. Note that this confirmation of device supply information is an option, and is not indispensable. A phase of this confirmation of device supply information corresponds to, for example, Provision Discovery in P2P. Next, both devices mutually confirm this device supply information, thereby deciding which one of them is to become a client of P2P, and which one of them is to become a group owner of P2P, as their roles. Next, once the client and the group owner have been decided, they exchange parameters for performing WFD communication with each other. Based on the exchanged parameters, processing of the remaining wireless connection and processing of IP connection are executed between the client and the group owner of P2P. Note that in the WFD mode, the communication apparatus 151 may not execute the aforementioned GO Negotiation, and the communication apparatus 151 may always operate as a GO. That is to say, the communication apparatus 151 may operate in a WFD mode that is an Autonomous GO mode. Also, a state where the communication apparatus 151 is operating in the WFD mode is, specifically, a state where WFD connection has not been established but the communication apparatus 151 is operating as a GO, or a state where WFD connection has been established and the communication apparatus 151 is operating as a GO, for example.

In the software AP mode, among devices that are to perform communication (e.g., the information processing apparatus 101 and the communication apparatus 151), one device (e.g., the information processing apparatus 101) becomes a client that plays a role of requesting various types of services. Also, another device realizes the functions of an AP in Wi-Fi by using settings of software. The software AP corresponds to a parent station of Wi-Fi, and the client corresponds to a child station of Wi-Fi. In the software AP mode, a client searches for a device to become a software AP by using a device search command. Once the software AP has been searched for, processing of the remaining wireless connection (e.g., establishment of wireless connection) is executed, and then processing of IP connection (e.g., allocation of IP addresses) is executed, between the client and the software AP. Note that regarding commands and parameters that are transmitted/received in a case where wireless connection is realized between a client and a software AP, it is sufficient to use those defined by the Wi-Fi standard, and a description thereof is omitted here.

In the present embodiment, in a case where the communication apparatus 151 has established and is maintaining direct connection, the communication apparatus 151 operates as a parent station inside a network to which it belongs. Note that a parent station is an apparatus that constructs a wireless network, and an apparatus that provides a child station with parameters used in connection to the wireless network. The parameters used in connection to the wireless network are, for example, parameters related to a channel used by the parent station. By receiving such parameters, the child station connects to the wireless network constructed by the parent station using the channel used by the parent station. In the direct connection mode, as the communication apparatus 151 operates as the parent station, the communication apparatus 151 can decide which frequency band is to be used, and which channel is to be used, in communication in the direct connection mode. It is assumed in the present embodiment that the communication apparatus 151 can use a channel corresponding to a 2.4 GHz frequency band and a channel corresponding to a 5 GHz frequency band for communication in the direct connection mode.

### <Regarding Infra Connection Method>

Infra connection is a connection style which connects to an AP (e.g., the AP 131) that performs integrated control on a network of devices that are to perform communication (e.g., the information processing apparatus 101 and the communication apparatus 151), and which allows the devices to communicate with each other via the AP. The communication apparatus 151 can also operate in a mode for performing communication via infra connection (an infra connection mode) as one of connection modes.

In infra connection, each device searches for the AP by using a device search command. Once the AP has been searched for, processing of the remaining wireless connection (e.g., establishment of wireless connection) is executed, and then processing of IP connection (e.g., allocation of IP addresses) is executed, between the devices and the AP. Note that regarding commands and parameters that are transmitted/received in a case where wireless connection is realized between the devices and the AP, it is sufficient to use those defined by the Wi-Fi standard, and a description thereof is omitted here.

In the present embodiment, when the communication apparatus 151 operates via infra connection, the AP 131 and the communication apparatus 151 operate as a parent station and a child station, respectively. That is to say, in the present embodiment, infra connection refers to connection between the communication apparatus 151 that operates as the child station and an apparatus that operates as a parent station. In a case where the communication apparatus 151 has established infra connection and the information processing apparatus 101 has also established infra connection with the AP 131, communication can be performed via the AP 131 between the communication apparatus 151 and the information processing apparatus 101. A channel used for communication in infra connection is decided by the AP 131; thus, the communication apparatus 151 executes communication in infra connection by using the channel decided by the AP 131. It is assumed in the present embodiment that the communication apparatus 151 can use a channel corresponding to the 2.4 GHz frequency band and a channel corresponding to the 5 GHz frequency band for communication in infra connection. Note that the communication apparatus 151 can also use a channel corresponding to a DFS band in the 5 GHz frequency band for communication in infra connection. Note that in order to communicate with the communication apparatus 151 via the AP 131, the information processing apparatus 101 recognizes and specifies that the communication apparatus 151 belongs to a network which has been formed by the AP 131 and to which the information processing apparatus 101 belongs.

### <Regarding Connection Setting Processing>

In the present embodiment, the information processing apparatus 101 executes connection setting processing (network setting processing), which is setting for causing the communication apparatus 151 to operate using at least one communication method among infra connection and direct connection, using wireless communication with the communication apparatus 151. The connection setting processing in the present embodiment is also called cableless setup (CLS) because it is executed via wireless communication. Note that the connection setting processing may be executed via wired communication. The information processing apparatus 101 executes the connection setting processing with respect to the communication apparatus 151 when the predetermined app stored in the external storage apparatus 106 and the like has been activated. The communication apparatus 151 can operate in a connection setting mode (connection setting state), which is a mode for executing the connection setting processing, and executes the connection setting processing in a state where it is operating in the later-described connection setting mode. The details of the connection setting mode will be described later.

To cause the communication apparatus 151 to operate in the infra connection mode, the information processing apparatus 101 wirelessly transmits, to the communication apparatus 151, infra setting information that is setting information for causing it to operate in the infra connection mode. The infra setting information includes information related to the AP 131. The information related to the AP 131 is, for example, information related to a service set identifier (SSID), a password, and a frequency band and the like.

On the other hand, to cause the communication apparatus 151 to operate in the direct connection mode, the information processing apparatus 101 wirelessly transmits, to the communication apparatus 151, direct setting information that is setting information for causing it to operate in the direct connection mode. The direct setting information includes an instruction for causing the communication apparatus 151 to enable the WFD function and operate as a group owner, and for enabling an access point setting thereof. Also, the information processing apparatus 101 obtains, from the communication apparatus 151, connection information that is necessary for direct connection with the communication apparatus 151. The connection information for direct connection with the communication apparatus 151 includes, for example, information of an SSID, a password, and the like of the communication apparatus 151 that is to operate in the direct connection mode.

In the present embodiment, direct connection for connection settings between the information processing apparatus 101 and the communication apparatus 151 is used to transmit the infra setting information and the direct setting information, and to obtain information for direct connection with the communication apparatus 151, in the connection setting processing. Also, although the connection setting processing that uses Wi-Fi is executed as direct connection for connection settings in the present embodiment, a wireless communication standard other than Wi-Fi, such as Bluetooth Classic, Bluetooth Low Energy, and the like, may be used. In addition, a wired communication standard, such as a wired LAN and a Universal Serial Bus (USB), may be used as direct connection for connection settings. Furthermore, in these styles, the information processing apparatus 101 may maintain Wi-Fi connection with the AP also while connection is established between the communication apparatus 151 operating in the connection setting mode and the information processing apparatus 101.

After infra connection or direct connection has been established between the information processing apparatus 101 and the communication apparatus 151 via Wi-Fi through the connection setting processing, the information processing apparatus 101 and the communication apparatus 151 can communicate with each other via the established connection. Specifically, for example, the information processing apparatus 101 can transmit, to the communication apparatus 151, a print job for causing the communication apparatus 151 to execute printing, and a scan job for causing the communication apparatus 151 to execute a scan, via the established connection. Note that although the connection setting processing enables the communication apparatus 151 to operate in the infra connection mode, and also enables the communication apparatus 151 to operate in the direct connection mode in the present embodiment, no limitation is intended by this style. For example, it is possible to adopt a style in which the connection setting processing enables the communication apparatus 151 to operate only in the infra connection mode (i.e., does not enable the communication apparatus 151 to operate in the direct connection mode).

### <Regarding Connection Setting Mode>

The communication apparatus 151 can operate in the connection setting mode. For example, a trigger for the communication apparatus 151 to start operating in the connection setting mode may be pressing of a button for the connection setting mode by the user, or may be the first activation (power ON) of the communication apparatus 151 after being delivered. The button for the connection setting mode may be a hardware button included in the communication apparatus 151, or may be a software button that is displayed on the display unit 161 by the communication apparatus 151.

When the communication apparatus 151 has started to operate in the connection setting mode, it enables both of Wi-Fi communication and BLE communication. Specifically, the communication apparatus 151 enables an AP inside the communication apparatus 151 dedicated to the connection setting mode (an AP for connection settings) as processing for enabling Wi-Fi communication. This places the communication apparatus 151 in a state where it can establish direct connection with the information processing apparatus 101 via Wi-Fi. Connection information (an SSID and a password) for connecting to the AP for connection settings is held in advance in the predetermined app installed on the information processing apparatus 101. That is to say, it is assumed that the information processing apparatus 101 has recognized the connection information for connecting to the AP for connection settings in advance. Therefore, it is assumed that, unlike connection information of an AP that is enabled in the direct connection mode, the connection information for connecting to the AP for connection settings cannot be arbitrarily changed by the user. Note that it is possible to adopt a style in which an encryption method is not set in the AP for connection settings, and a password is unnecessary in connection with this AP. Note that in the connection setting mode, the communication apparatus 151 may connect to the information processing apparatus 101 via Wi-Fi Direct (WFD), rather than normal Wi-Fi. That is to say, the communication apparatus 151 may operate as a group owner, and receive a setting command from the information processing apparatus 101 via WFD communication.

<Regarding Registration of Communication Apparatus with App>

In the present embodiment, the predetermined app obtains information related to the communication apparatus 151 from the communication apparatus 151; in this way, the communication apparatus 151 can be registered with the predetermined app. The information related to the communication apparatus 151 is, for example, capability information of the communication apparatus 151, identification information (e.g., a MAC address) of the communication apparatus 151, model information of the communication apparatus 151, and the like. The capability information of the communication apparatus 151 specifically includes a list of pieces of information of functions supported by the communication apparatus 151, information of consumables (ink and sheet) usable in the communication apparatus 151, information indicating a printing method of the communication apparatus 151, and the like. Then, the predetermined app selects one apparatus that is to become a communication partner of the predetermined app from among one or more communication apparatuses 151 registered with the predetermined app. Hereinafter, a communication apparatus 151 that is currently selected as an apparatus that is to become a communication partner of the predetermined app will be referred to as a currently-selected communication apparatus 151. Note that a selection of an apparatus that is to become a communication partner of the predetermined app may be executed by accepting, from the user, a selection from among one or more communication apparatuses 151 registered with the predetermined app, or may be automatically executed by the predetermined app in accordance with a predetermined criterion. Also, changing of an apparatus that is to become a communication partner of the predetermined app may be executed by, for example, accepting, from the user, a selection from among one or more communication apparatuses 151 registered with the predetermined app. In the present embodiment, the predetermined app transmits various types of jobs, such as a print job and a scan job, to the currently-selected communication apparatus 151. That is to say, the currently-selected communication apparatus 151 is an apparatus to which various types of jobs are transmitted.

The information processing apparatus 101, such as a smartphone, temporarily connects to the communication apparatus 151, such as a printer, and transmits information related to an access point to which the information processing apparatus 101 was connected immediately before the temporary connection to the communication apparatus 151. This can cause the information processing apparatus 101 and the communication apparatus 151 to connect to access points with the same SSID. In order to obtain information of the access point to which the information processing apparatus 101 was connected immediately before the temporary connection to the communication apparatus 151 from the operating system (hereinafter, OS), it is necessary to accept a permission operation for the use of position information by the application from the user. To accept the permission operation for the use of position information, for example, the application needs to call an application programming interface (API) of the OS, display a dialog screen of the OS for accepting the permission operation for the use of position information, and accept the permission operation from the user. As another method, it is conceivable that the user be directed from the application to accept the permission operation for the use of position information on a standard setting application of the OS. However, in order to render a user operation easy, it is desirable to display a dialog screen of the OS for accepting the permission operation for the use of position information by the application. Also, the states of the application related to the use of position information include a state where neither an operation for permission nor an operation for prohibition has been performed (hereinafter, an unpermitted state), a state where an operation for permission has been performed (hereinafter, a permitted state), and a state where an operation for prohibition has been performed (hereinafter, a prohibited state). In the permitted state, information of the access point to which the information processing apparatus 101 is connected can be obtained from the OS. However, in other states, the application cannot obtain this information from the OS. Therefore, in the case of other states, the communication apparatus cannot be connected to the access point with the SSID to which the information processing apparatus 101 was connected immediately before the temporary connection to the communication apparatus 151. Thus, there is a need to present the user with an appropriate method for accepting a permission operation for the use of position information in accordance with a state of the application related to the use of position information.

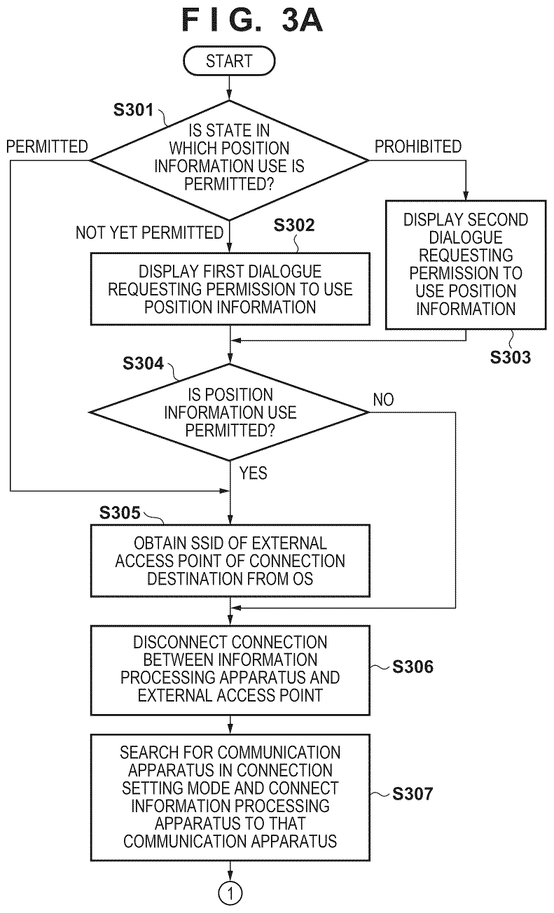

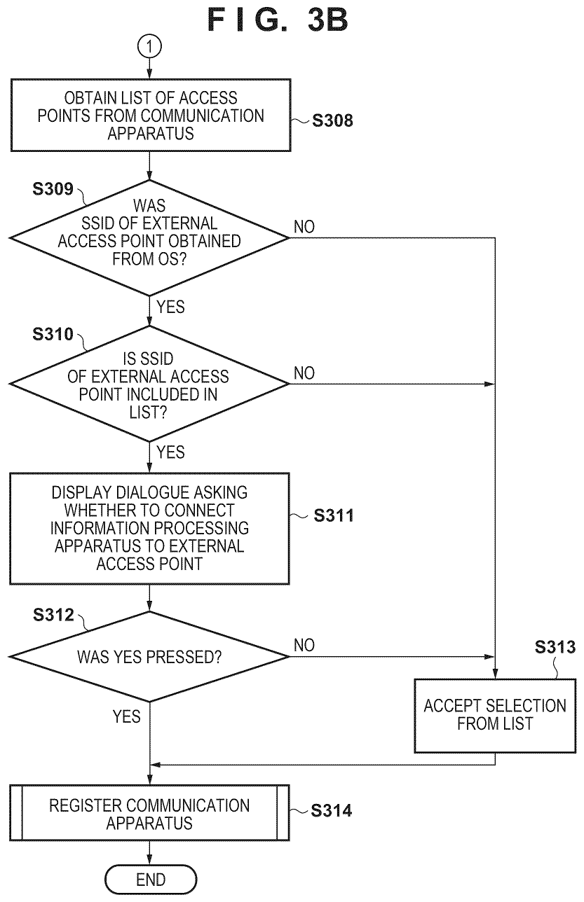

Next, a processing flow of the present embodiment will be described using FIGS. 3A and 3B. FIGS. 3A and 3B are flowcharts showing processing including the connection setting processing of the present embodiment. The processing of FIGS. 3A and 3B is realized by, for example, the CPU 103 of the information processing apparatus 101 reading out a program, such as a predetermined app, stored in the ROM 104 to the RAM 105 and executing the same. Also, the present flowchart is started based on the execution of the following predetermined operation(s) for executing the connection setting processing of the communication apparatus 151 on a screen displayed by the predetermined app. The predetermined app is an application that has a function for achieving a state where the information processing apparatus 101 and the communication apparatus 151 can communicate with each other, and a function for registering the communication apparatus 151 in a communication-enabled state. Note that the function for achieving the state where the information processing apparatus 101 and the communication apparatus 151 can communicate with each other is specifically a function that executes the connection setting processing. Furthermore, the predetermined app may have other functions in addition to the function that executes the connection setting processing. For example, the predetermined app may have a function of selecting print information to be transmitted to the communication apparatus 151, and a function of configuring other settings of the communication apparatus 151.

First, the predetermined app displays a screen that prompts the user to cause the communication apparatus 151 to operate in the connection setting mode (e.g., a guidance screen) on the information processing apparatus 101. Note that an instruction to the user may be issued by the communication apparatus 151. The user causes the communication apparatus 151 to operate in the connection setting mode in accordance with the instruction. At this time, as stated earlier, the communication apparatus 151 that has been placed in the connection setting mode transmits a signal including the SSID of the AP for connection settings to the surroundings. Thereafter, when the user has started a function of executing the connection setting processing of the information processing apparatus 101 (e.g., pressed a “next” button (not shown) on the screen displayed by the predetermined app), the predetermined app starts processing shown in FIGS. 3A and 3B.

In step S301, the CPU 103 determines a state of the predetermined app related to the use of position information of the information processing apparatus 101. This determination is made by, for example, the predetermined app calling an API of the OS of the information processing apparatus 101, and obtaining a state of an application related to the use of position information (here, the predetermined app). The states of the predetermined app related to the use of position information include a state where neither an operation for permission nor an operation for prohibition has been performed (hereinafter, an unpermitted state), a state where an operation for permission has been performed (hereinafter, a permitted state), and a state where an operation for prohibition has been performed (hereinafter, a prohibited state). In a case where it has been determined that the state of the predetermined app related to the use of position information is the unpermitted state, processing proceeds to step S302. In a case where it has been determined that the state of the predetermined app related to the use of position information is the prohibited state, processing proceeds to step S303. In a case where it has been determined that the state of the predetermined app related to the use of position information is the permitted state, processing proceeds to step S305.

To change the state of the predetermined app related to the use of position information, it is necessary to accept a permission operation for the use of position information from the user on the dialog screen of the OS for accepting a permission operation for the use of position information, or accept a permission operation for the use of position information on a screen displayed by the standard setting app of the OS. In the present embodiment, in order to accept a permission operation for the use of position information, the predetermined app calls up an API of the OS and displays a dialog screen of the OS for accepting a permission operation for the use of position information in steps S302 and S303. In the present embodiment, a displayable dialog screen of the OS varies depending on the state of the predetermined app related to the use of position information. That is to say, the dialog screens of the OS that are displayed respectively in steps S302 and S303 are different from each other. Hereinafter, the dialog screen of the OS displayed in step S302 will be referred to as a first dialog screen, and the dialog screen of the OS displayed in step S303 will be referred to as a second dialog screen.

In step S302, the CPU 103 displays the first dialog screen for accepting a permission operation for the use of position information. In step S302, the first dialog screen is displayed as a result of the predetermined app calling an API of the OS. This API is an API for causing the OS to display the first dialog screen of the OS for accepting a permission operation for the use of position information from the user, and the predetermined app can cause the OS to display the first dialog screen by calling this API.

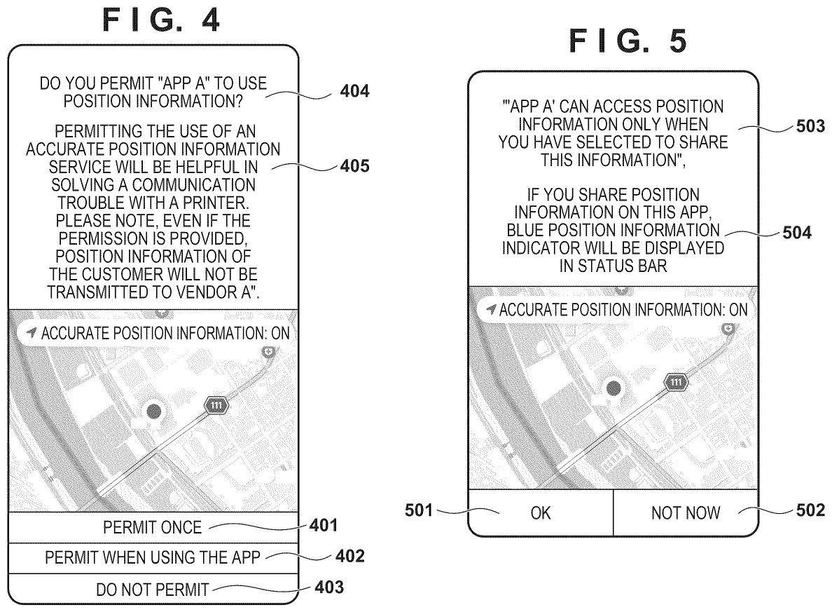

FIG. 4 is a diagram showing an example of the first dialog screen displayed in step

S302. A text display region 404 is a region that is displayed by the OS using the name of the predetermined app. FIG. 4 shows an example in which the OS displays “Do you permit ‘app A’ to use position information?” using the name “app A” of the predetermined app. A text display region 405 is a region in which the predetermined app designates text when calling an API of the OS. For example, the predetermined app can include the designated text in an API to cause the OS to display a dialog screen including this text. FIG. 4 shows an example in which the app designates the text as follows: “Permitting the use of an accurate position information service will be helpful in solving a communication trouble with a printer. Please note, even if the permission is provided, position information of the customer will not be transmitted to vendor A”. In this way, the first dialog screen includes a region in which the OS designates text, and a region in which the predetermined app designates text.

Furthermore, the first dialog screen includes buttons 401 and 402 for accepting a permission operation from the user, and a button 403 for accepting a prohibition operation from the user. When the button 401 (the “permit once” button in FIG. 4) has been pressed, the OS sets the state of the predetermined app related to the use of position information from the unpermitted state to the permitted state. Then, when the button 401 has been pressed, this permitted state continues until one of the following conditions is met.
Until the predetermined app operates in the background without enabling a usage status indicator of background position information.
Until the usage status indicator of background position information is disabled after the predetermined app has enabled the usage status indicator of background position information and operated in the background.
Until the prohibited state is set by an operation performed on the standard setting app of the OS or the first dialog screen.

Note that after the button 401 has been pressed, in a case where the prohibited state has been set upon cancellation of the permitted state, the permitted state is not automatically resumed even if the predetermined app has operated in the foreground again.

When the button 402 (the “permit when using the app” button in FIG. 4) has been pressed, the OS sets the state of the predetermined app related to the use of position information from the unpermitted state to the permitted state. Then, when the button 402 has been pressed, this permitted state continues until one of the following conditions is met.
. Until the predetermined app operates in the background without enabling the usage status indicator of background position information.
Until the usage status indicator of background position information is disabled after the predetermined app has enabled the usage status indicator of background position information and operated in the background.

Note that after the button 402 has been pressed, in a case where the prohibited state has been set upon cancellation of the permitted state, the permitted state is automatically resumed, without the user performing an operation, in a case where the predetermined app has operated in the foreground again.

When the button 403 (the “do not permit” button in FIG. 4) has been pressed, the OS sets the state of the predetermined app related to the use of position information from the unpermitted state to the prohibited state.

In step S303, the CPU 103 displays the second dialog screen for accepting a permission operation for the use of position information. In step S303, the second dialog screen is displayed as a result of the predetermined app calling an API of the OS. This API is an API for causing the OS to display the second dialog screen of the OS for accepting a permission operation for the use of position information from the user, and the predetermined app can cause the OS to display the second dialog screen by calling this API. Note that the API called to display the second dialog screen is an API different from the API called to display the first dialog screen.

FIG. 5 is a diagram showing an example of the second dialog screen displayed in step S303. Text display regions 503 and 504 are both regions that are displayed by the OS using the name of the predetermined app, and the predetermined app cannot designate text displayed in these regions. FIG. 5 shows an example in which the OS displays, in the text display region 503, “App A′ can access position information only when you have selected to share this information”, using the name “app A” of the predetermined app.

Furthermore, the second dialog screen includes a button 501 for accepting a permission operation from the user, and a button 502 for accepting a prohibition operation from the user. When the button 501 (the “OK button” in FIG. 5) has been pressed, the state of the predetermined app related to position information is set from the prohibited state to the permitted state. Then, when the button 501 has been pressed, this permitted state continues until one of the following conditions is met.
Until the predetermined app operates in the background without enabling the usage status indicator of background position information.
Until the usage status indicator of background position information is disabled after the predetermined app has enabled the usage status indicator of background position information and operated in the background.
Until the prohibited state is set by an operation performed on the standard setting app of the OS or the first dialog screen.

Note that after the button 501 has been pressed, in a case where the prohibited state has been set upon cancellation of the permitted state, the permitted state is not automatically resumed even if the predetermined app has operated in the foreground again.

When the button 502 (the “not now” button in FIG. 5) has been pressed, the state of the predetermined app related to the use of position information is not changed from the prohibited state.

As described above, in the present embodiment, displayed text (message) differs between the first dialog screen and the second dialog screen. In other words, processing of steps S301 to S303 is display control processing that makes a dialogue to be displayed by the OS differ depending on the state of the predetermined app related to the use of position information. Specifically, for example, the first dialog screen is a screen that includes a region in which the predetermined app can designate text, and the second dialog screen is a screen in which the predetermined app cannot designate text. Also, for example, the first dialog screen is a screen that includes two types of buttons 401 and 402 for accepting a permission operation from the user, and the second dialog screen is a screen that includes one type of button 501 for accepting a permission operation from the user. The present embodiment has been described under the assumption that the first dialog screen is displayed in a case where the state of the predetermined app related to the use of position information is the unpermitted state, and the second dialog screen is displayed in a case where the state is the prohibited state. However, the second dialog screen may be displayed whether the state of the predetermined app related to the use of position information is the unpermitted state or the prohibited state. When any of the buttons 401 to 403, 501, and 502 has been pressed, processing proceeds to step S304. Also, in steps S302 and S303, the CPU 103 may display a dialog screen showing a description related to the use of position information before displaying the first dialog screen and the second dialog screen.

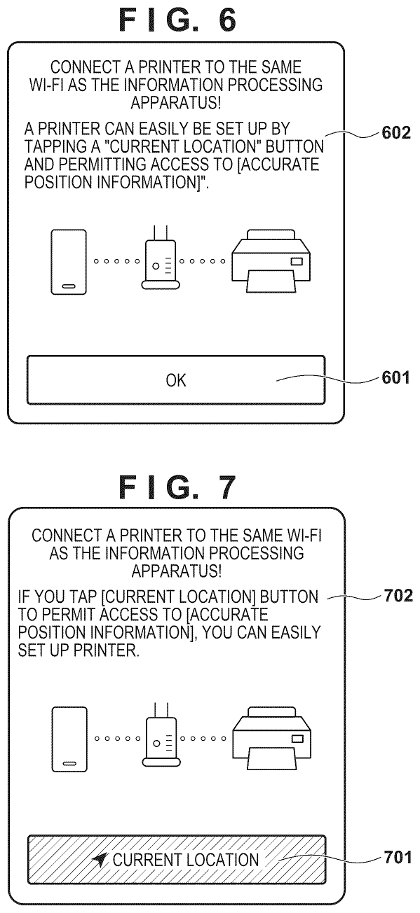

FIG. 6 is a diagram showing an example of a dialog screen which is displayed before the first dialog screen is displayed, and which shows a description related to the use of position information. FIG. 7 is a diagram showing an example of a dialog screen which is displayed before the second dialog screen is displayed, and which shows a description related to the use of position information. A dialog showing a description related to the use of position information is a screen displayed by the predetermined app, rather than an OS screen that is displayed as a result of the predetermined app calling an API of the OS like the first dialog screen and the second dialog screen.

The dialog screen of FIG. 6 is a screen displayed in step S302, and a text display region 602 displays text of a description related to the use of position information. For example, the screen of FIG. 6 displays text that prompts a permission operation on the first dialog screen displayed by the OS, like “Connect a printer to the same Wi-Fi as the information processing apparatus 101! To easily set up a printer, please permit the use of [accurate position information] on the next screen”. The dialog screen of FIG. 6 includes a button 601. The button 601 is a button for calling the API of the OS for causing the OS to display the first dialog screen. That is to say, for example, when the button 601 has been pressed, the predetermined app calls up the API of the OS and causes the OS to display the first dialog screen of FIG. 4. Here, the text of the button 601 (“OK” in FIG. 6) is text that can be designated by the predetermined app.

The dialog screen of FIG. 7 is a screen displayed in step S303, and a text display region 702 displays text of a description related to the use of position information. For example, the dialog screen of FIG. 7 displays text that prompts a permission operation on the second dialog screen displayed by the OS, like “Connect a printer to the same Wi-Fi as the information processing apparatus 101! A printer can easily be set up by tapping a “current location” button and permitting access to [accurate position information]”. The dialog screen of FIG. 7 includes a button 701. The button 701 is a button for calling the API of the OS for causing the OS to display the second dialog screen. That is to say, for example, when the button 701 has been pressed, the predetermined app calls up the API of the OS and causes the OS to display the second dialog screen of FIG. 5. Here, the text of the button 701 (“current location” in FIG. 7) is text that has been designated in advance by the OS, and is text that cannot be designated by the predetermined app.

In step S304, the CPU 103 determines whether the state of the predetermined app related to the use of position information is the permitted state. Specifically, for example, whether a button for setting the permitted state has been pressed is determined. In a case where it has been determined that the state of the predetermined app related to the use of position information is the permitted state, the state of the predetermined app related to the use of position information is regarded as the permitted state, and processing proceeds to step S305; in a case where it has been determined that the state is not the permitted state, processing proceeds to step S306.

In step S305, as the state of the predetermined app is the permitted state, the CPU 103 executes processing for obtaining the SSID of the access point 131 to which the information processing apparatus 101 is currently connected from the OS. The obtained SSID is saved in a predetermined storage region, such as a memory.

In step S306, the CPU 103 executes processing for disconnecting the connection between the information processing apparatus 101 and the access point 131.

In step S307, the CPU 103 searches for an access point of the communication apparatus 151 in the connection setting mode (an access point for connection settings). As the SSID of the access point inside the communication apparatus 151 in the connection setting mode is generated in accordance with a generation rule, the access point corresponding to the SSID that matches the generation rule is searched for. Then, the CPU 103 causes the information processing apparatus 101 to connect to the discovered access point of the communication apparatus 151 in the connection setting mode. Note that in a case where a plurality of access points have been discovered, it is possible to display a list of the discovered SSIDs for the user, accept a selection, and cause the information processing apparatus 101 to connect to an access point of the communication apparatus 151 corresponding to the selected SSID.

In step S308, the CPU 103 requests the communication apparatus 151 for a list of access points which exist around the communication apparatus 151 and to which the communication apparatus 151 can connect. At this time, the communication apparatus 151 that has received the request executes a search for access points, and transmits a result of this search to the information processing apparatus 101. Then, the CPU 103 obtains, from the communication apparatus 151, the list of access points which exist around the communication apparatus 151 and to which the communication apparatus 151 can connect. The list of access points is, for example, a list of SSIDs.

In step S309, the CPU 103 determines whether the SSID of the access point 131 has been obtained in step S305. Specifically, for example, in a case where the SSID of the access point 131 is stored in the predetermined storage region, it is determined that the SSID of the access point 131 has been obtained in step S305. In a case where it has been determined that the SSID of the access point 131 has been obtained, processing proceeds to step S310; in a case where it has been determined that the SSID has not been obtained, processing proceeds to step S313.

In step S310, the CPU 103 determines whether the SSID of the access point 131 obtained in step S305 is included in the list of access points obtained in step S308. In a case where it has been determined that the SSID is included in the list of access points, processing proceeds to step S311; in a case where it has been determined that the SSID is not included, processing proceeds to step S313.

In step S311, the CPU 103 displays a dialog screen that inquires whether to cause the communication apparatus 151 to connect to the SSID of the access point 131 obtained in step S305.

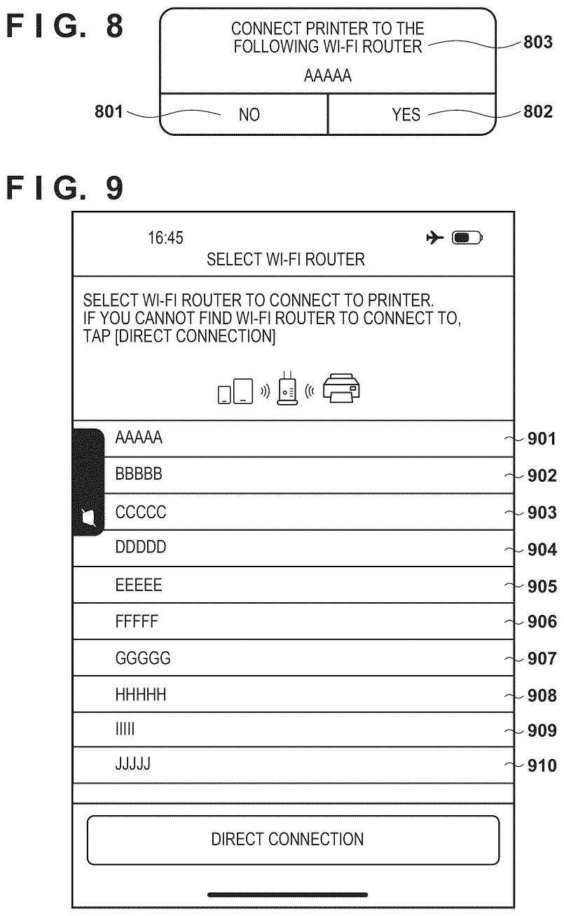

FIG. 8 is a diagram showing an example of a dialog screen displayed in step S311. As shown in FIG. 8, a text display region 803 displays text that inquires whether to cause the communication apparatus 151 to connect to the access point 131 using the SSID of the access point 131 obtained in step S305 (“AAAAA” in FIG. 8). In step S312, the CPU 103 determines whether to cause the communication apparatus 151 to connect to the access point 131 obtained in step S305. In a case where it has been determined that the communication apparatus 151 is to connect to the access point 131 obtained in step S305, processing proceeds to step S314; in a case where it has been determined that the communication apparatus 151 is not to connect to the access point 131 obtained in step S305, processing proceeds to step S313. Specifically, for example, processing proceeds to step S314 in a case where a “yes” button 802 on the dialog screen of FIG. 8 has been pressed, and processing proceeds to step S313 in a case where a “no” button 801 has been pressed.

In step S313, based on the list of access points obtained in step S308, the CPU 103 displays a list of access points which exist around the communication apparatus 151 and to which the communication apparatus 151 can connect. FIG. 9 is a diagram showing an example of a screen displayed in step S313. As shown in FIG. 9, the list displays SSIDs 901 to 910 as a list of SSIDs. Then, when the user has selected a desired SSID from the list, processing proceeds to step S314.

FIG. 10 is a flowchart showing processing of step S314.

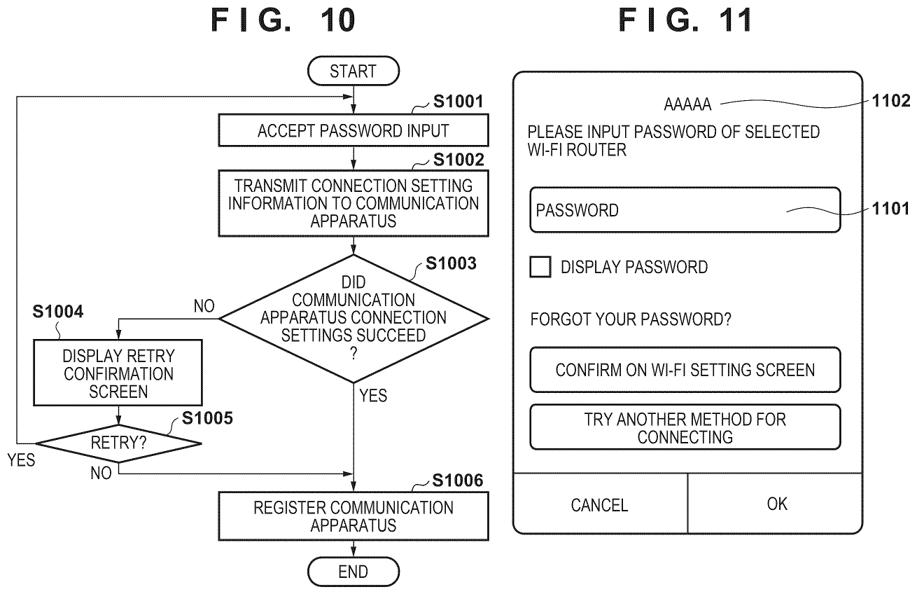

In step S1001, the CPU 103 accepts, from the user, an input of a password for connecting to an access point corresponding to the SSID that has been shown in step S311 or selected in step S313. FIG. 11 is a diagram showing an example of an input screen displayed in step S1001. As shown in FIG. 11, a text display region 1102 displays the SSID (e.g., “AAAAA”) selected from the list, and text that prompts inputting of a password for connecting to an access point corresponding to this SSID. Then, the CPU 103 obtains password information that has been input to an input region 1101 by the user. It is assumed here that a password for connecting to the access point 131 has been input.

In step S1002, the CPU 103 transmits, to the communication apparatus 151, connection setting information for causing the communication apparatus 151 to connect to the access point 131. Here, the connection setting information includes the SSID of the access point 131 obtained in step S311 or S313, the password obtained in step S1001, a command for setting a connection mode of the communication apparatus 151, for example. Here, the command for setting a connection mode of the communication apparatus 151 is a command for setting the infra connection mode on the communication apparatus 151. Upon receiving the connection setting information, the communication apparatus 151 executes connection to the access point 131 based on this connection setting information. As a result, the information processing apparatus 101 and the communication apparatus 151 connect to the same access point; consequently, the information processing apparatus 101 and the communication apparatus 151 arc connected to each other via infra connection, and high-speed communication via the wireless LAN is enabled therebetween.

After the connection setting information has been transmitted in step S1002, the CPU 103 determines in step S1003 whether connection (connection settings) of the communication apparatus 151 to the access point 131 based on the transmitted connection setting information has succeeded. Specifically, for example, the CPU 103 waits for a notification related to whether the connection settings have succeeded from the communication apparatus 151. Then, in a case where this notification has been received, the CPU 103 analyzes the content of this notification, and determines whether the connection settings of the communication apparatus 151 have succeeded based on the result of this analysis.

In a case where it has been determined that the connection settings of the communication apparatus 151 have failed, the CPU 103 displays a screen for confirming with the user whether to retry the connection settings of the communication apparatus 151 (not shown) on the display unit 108 in step S1004. Then, in step S1005, the CPU 103 determines whether to retry the connection settings of the communication apparatus 151 based on a user input on this screen. In a case where it has been determined that the connection settings of the communication apparatus 151 are to be retried, processing is repeated from step S1001. On the other hand, in a case where it has been determined that the connection settings of the communication apparatus 151 are not to be retried, processing of FIG. 10 is ended.

In a case where it has been determined that the connection settings of the communication apparatus 151 have succeeded in step S1003, the CPU 103 registers the communication apparatus 151 targeted for the connection settings as a communication destination of the information processing apparatus 101 in step S1006. Specifically, for example, in order to communicate with the communication apparatus 151 via the AP 131, the information processing apparatus 101 first recognizes and specifies that the communication apparatus 151 belongs to a network which has been formed by the AP 131 and to which the information processing apparatus 101 belongs. Then, the CPU 103 obtains information related to the communication apparatus 151 from the communication apparatus 151 using the predetermined app, and registers the communication apparatus 151 with the predetermined app.

As described above, according to the present embodiment, display of a dialog screen for accepting a permission operation for the use of position information can be appropriately controlled in accordance with a state of the predetermined app related to the use of position information. Therefore, the opportunity to accept a permission for the use of position information can be increased, and a possibility of failure in the SSID of the access point 131 to which the information processing apparatus 101 is connected can be reduced. Furthermore, in a case where the SSID of the access point 131 to which the information processing apparatus 101 is connected has been obtained, processing for causing the information processing apparatus 101 and the communication apparatus 151 to connect to the access point 131 is executed without causing the user to select the SSID, and thus the usability can be improved.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-145867, filed Aug. 27, 2024 which is hereby incorporated by reference herein in its entirety.

What is claimed is:

1. A method of controlling an information processing apparatus capable of accepting a first operation for permitting a predetermined application program to use position information, and a second operation for not permitting the predetermined application program to use the position information, the method comprising:
executing processing for obtaining information of a predetermined access point to which the information processing apparatus is connected from an operating system (OS) of the information processing apparatus based on a state where the predetermined application program is in a first state which is a state where the predetermined application program is permitted to use the position information, and which is a state based on a state where the first operation has been executed;
transmitting the information of the predetermined access point obtained from the OS of the information processing apparatus to a communication apparatus;
executing processing for displaying a first dialog screen which is a dialog screen for placing the predetermined application program in the first state, and which is a dialog screen displayed by the OS of the information processing apparatus, based on a state where the predetermined application program is in a second state which is a state based on a state where neither the first operation nor the second operation has been executed; and
executing processing for displaying a second dialog screen which is a dialog screen for placing the predetermined application program in the first state, which is a dialog screen displayed by the OS of the information processing apparatus, and which is different from the first dialog screen, based on a state where the predetermined application program is a third state which is a state where the predetermined application program is not permitted to use the position information, and which is a state based on a state where the second operation has been executed.

2. The method according to claim 1, further comprising:
executing the processing for obtaining the information of the predetermined access point from the OS of the information processing apparatus in a case where the first operation has been executed on the displayed first dialog screen; and
executing the processing for obtaining the information of the predetermined access point from the OS of the information processing apparatus in a case where the first operation has been executed on the displayed second dialog screen.

3. The method according to claim 2, wherein
in a case where the first operation has not been executed on the displayed first dialog screen, or in a case where the first operation has not been executed on the displayed second dialog screen, the processing for obtaining the information of the predetermined access point from the OS of the information processing apparatus is not executed.

4. The method according to claim 3, further comprising:
obtaining a list of access points discovered through a search executed by the communication apparatus from the communication apparatus;
executing processing for displaying the obtained list in a case where the first operation has not been executed on the displayed first dialog screen, or in a case where the first operation has not been executed on the displayed second dialog screen;
accepting a selection of an access point from the displayed list; and
transmitting information of the access point selected from the displayed list to the communication apparatus.

5. The method according to claim 4, further comprising:
establishing connection between the information processing apparatus and the communication apparatus in a predetermined mode,
wherein the list is obtained from the communication apparatus via the established connection.

6. The method according to claim 5, wherein
the information of the predetermined access point is transmitted to the communication apparatus via the established connection.

7. The method according to claim 1, further comprising:
displaying an inquiry screen for inquiring of a user whether to cause the communication apparatus to an access point to which the information processing apparatus is connected based on the information of the predetermined access point obtained from the OS of the information processing apparatus.

8. The method according to claim 7, further comprising:
obtaining a list of access points discovered through a search executed by the communication apparatus from the communication apparatus;
executing processing for displaying the obtained list in a case where an input corresponding to prevention of connection of the communication apparatus to the predetermined access point has been performed on the inquiry screen;
accepting a selection of an access point from the displayed list; and
transmitting information of the access point selected from the displayed list to the communication apparatus.

9. The method according to claim 8, wherein
in a case where the obtained list includes the predetermined access point, the inquiry screen is displayed, and in a case where the obtained list does not include the predetermined access point, the list is displayed.

10. The method according to claim 9, further comprising:
establishing connection between the information processing apparatus and the communication apparatus in a predetermined mode,
wherein the list is obtained from the communication apparatus via the established connection.

11. The method according to claim 10, wherein
connection between the information processing apparatus and the communication apparatus in the predetermined mode is established after disconnection of connection between the information processing apparatus and the predetermined access point.

12. The method according to claim 10, wherein
the information of the predetermined access point is transmitted to the communication apparatus via the established connection.

13. The method according to claim 1, wherein
on the first dialog screen, the information processing apparatus is capable of accepting the first operation and the second operation, and is capable of accepting a first type of operation and a second type of operation as the first operation, and
on the second dialog screen, the information processing apparatus is capable of accepting the first operation and the second operation, and is capable of accepting the first type of operation but is not capable of accepting the second type of operation as the first operation.

14. The method according to claim 13, wherein
the information processing apparatus is further capable of accepting the first operation and the second operation on a screen displayed by a standard application program of the OS of the information processing apparatus.

15. The method according to claim 13, wherein
in a case where the first type of operation or the second type of operation has been executed, the predetermined application program is placed in a state where the predetermined application program is permitted to use the position information, and this state continues until the predetermined application program operates in a background.

16. The method according to claim 15, wherein
in a case where the predetermined application program has been placed in a state where the predetermined application program is not permitted to use the position information based on a state where the second operation has been executed after the first type of operation has been executed, even when the predetermined application program operates in a foreground again, the predetermined application program is not placed in a state where the predetermined application program is permitted to use the position information without intervention of a user operation.

17. The method according to claim 15, wherein
in a case where the predetermined application program has been placed in a state where the predetermined application program is not permitted to use the position information based on a state where the second operation has been executed after the second type of operation has been executed, when the predetermined application program operates in a foreground again, the predetermined application program is placed in a state where the predetermined application program is permitted to use the position information without intervention of a user operation.

18. The method according to claim 1, further comprising:
accepting an input of a password,
wherein
the information of the access point obtained from the OS of the information processing apparatus includes a service set identifier (SSID) but does not include a password, and
the SSID obtained from the OS of the information processing apparatus and the input password are transmitted to the communication apparatus.

19. The method according to claim 1, wherein
the OS of the information processing apparatus is iOS or iPadOS.

20. An information processing apparatus that includes a predetermined application program and is capable of accepting a first operation for permitting the predetermined application program to use position information, and a second operation for not permitting the predetermined application program to use the position information, the information processing apparatus comprising
at least one memory and at least one processor which function as:
an obtainment unit configured to execute processing for obtaining information of a predetermined access point to which the information processing apparatus is connected from an operating system (OS) of the information processing apparatus based on a state where the predetermined application program is in a first state which is a state where the predetermined application program is permitted to use the position information, and which is a state based on a state where the first operation has been executed;
a transmission unit configured to transmit the information of the predetermined access point obtained from the OS of the information processing apparatus to the communication apparatus;
a first processing unit configured to execute processing for displaying a first dialog screen which is a dialog screen for placing the predetermined application program in the first state, and which is a dialog screen displayed by the OS of the information processing apparatus, based on a state where the predetermined application program is in a second state which is a state based on a state where neither the first operation nor the second operation has been executed; and
a second processing unit configured to execute processing for displaying a second dialog screen which is a dialog screen for placing the predetermined application program in the first state, which is a dialog screen displayed by the OS of the information processing apparatus, and which is different from the first dialog screen, based on a state where the predetermined application program is a third state which is a state where the predetermined application program is not permitted to use the position information, and which is a state based on a state where the second operation has been executed.

21. A non-transitory computer-readable storage medium that stores one or more programs including instructions of a predetermined application program, wherein
when executed by one or more processors of an information processing apparatus that is capable of accepting a first operation for permitting the predetermined application program to use position information, and a second operation for not permitting the predetermined application program to use the position information, the instructions:
execute processing for obtaining information of a predetermined access point to which the information processing apparatus is connected from an operating system (OS) of the information processing apparatus based on a state where the predetermined application program is in a first state which is a state where the predetermined application program is permitted to use the position information, and which is a state based on a state where the first operation has been executed;
transmit the information of the predetermined access point obtained from the OS of the information processing apparatus to the communication apparatus;
execute processing for displaying a first dialog screen which is a dialog screen for placing the predetermined application program in the first state, and which is a dialog screen displayed by the OS of the information processing apparatus, based on a state where the predetermined application program is in a second state which is a state based on a state where neither the first operation nor the second operation has been executed; and
execute processing for displaying a second dialog screen which is a dialog screen for placing the predetermined application program in the first state, which is a dialog screen displayed by the OS of the information processing apparatus, and which is different from the first dialog screen, based on a state where the predetermined application program is a third state which is a state where the predetermined application program is not permitted to use the position information, and which is a state based on a state where the second operation has been executed.
